(19) United States
(12) Patent Application Publication
(10) Pub. No.: US 2014/0218247 A1
(43) Pub. Date: Aug. 7, 2014

(54) ANTENNA ARRANGEMENT

(71) Applicant: NOKIA CORPORATION, Espoo (FI)

(72) Inventor: Faton Tefiku, San Diego, CA (US)

(73) Assignee: Nokia Corporation, Espoo (FI)

(21) Appl. No.: 13/758,474

(22) Filed: Feb. 4, 2013

(51) Int. Cl. H01Q 21/30; H01P 11/00; H01Q 1/50

(52) U.S. Cl. CPC H01Q 21/30; H01Q 1/50; H01P 11/00
USPC 343/752; 343/850; 29/600

(57) ABSTRACT

An antenna, a portable electronic device incorporating an antenna and a method of operation are provided. The antenna includes a first radiator extending from a first end configured to be coupled to radio frequency circuitry to a second end that is electrically open. The antenna also includes a second radiator extending from a first end that is configured to be grounded to a second end that is electrically open. The antenna is configured such that the second end of one of the first or second radiators is electrically coupled to the other of the first or second radiators at a coupling region between the first and second ends of the other of the first or second radiators. The second end of the second radiator may be electrically coupled to the first radiator at a location between the first and second ends of the first radiator.

### TECHNOLOGICAL FIELD

An example embodiment of the present invention relates generally to an antenna arrangement and, more particularly, to an antenna arrangement having a coupled-fed loop antenna.

### BACKGROUND

Portable electronic devices, such as cellular telephones, smart phones, tablet computers, laptop computers, personal digital assistants (PDAs), gaming devices, navigation systems, audio devices, video devices, cameras and the like, frequently include one or more antennas so as to facilitate wireless communication. Portable electronic devices generally include a housing with one or more antennas positioned within, on or as part of the housing. As a result of the continued emphasis upon the reduction in the size of portable electronic devices, the volume within the housing of a portable electronic device that may be occupied by an antenna is generally correspondingly limited.

However, advances in wireless communication systems, such as diversity, multiple input multiple output (MIMO) and simultaneous voice long term evolution (SV-LTE) applications, may require a portable electronic device to have an increased number of antennas. Additionally, portable electronic devices that are configured to support fourth generation communication systems may be required to operate within additional and/or larger cellular frequency bands and may correspondingly require additional antennas, particularly to support the lower cellular frequency bands.

By way of example, a cellular telephone may include a hexaband antenna that supports communications within a lower frequency band, such as from 704 MHz to 960 MHz, and a higher frequency band, such as from 1710 MHz to 2170 MHz. A passive hexaband antenna may be relatively large and may be difficult to integrate with other nearby electronic components of the cellular telephone, such as, but not limited to, the universal serial bus (USB) connector, microphone, integrated high frequency (IHF) speaker, user interface (UI) keys, etc. Moreover, in order to support diversity and/or MIMO applications, a cellular telephone may be required to have one or more additional antennas. These additional antennas may be positioned along the side or at the top of the cellular telephone, thereby causing the cellular telephone to be larger and to have an altered appearance. Similarly, a cellular telephone that is configured to support SV-LTE communications may require an additional antenna so as to simultaneously support voice communications with one antenna and data communications with another antenna. The additional antenna required to support SV-LTE communications may also increase the size and change the appearance of the cellular telephone.

### BRIEF SUMMARY

An antenna, a portable electronic device incorporating an antenna and a method of operation are provided in accordance with example embodiments of the present invention. The antenna may be designed in accordance with one embodiment to the present invention so as to have a relatively small size, while being configured to be independently tuned for within both a low frequency band and a high frequency band. Thus, the antenna of one embodiment of the present invention may be utilized by portable electronic devices so as to support the additional requirements imposed by advances in wireless communication systems, while permitting the portable electronic devices to be relatively small and aesthetically pleasing in appearance.

In one embodiment, an antenna is provided that includes a first radiator extending from a first end configured to be coupled to radio frequency circuitry to a second end that is electrically open. The antenna of this embodiment also includes a second radiator extending from a first end that is configured to be grounded to a second end that is electrically open. The antenna of this embodiment is configured such that the second end of one of the first or second radiators is electrically coupled to the other of the first or second radiators at a coupling region between the first and second ends of the other of the first or second radiators. For example, the second end of the second radiator may be electrically coupled to the first radiator at a location between the first and second ends of the first radiator. The combination of the first radiator, the second radiator and the coupling region therebetween may form, for example, a loop antenna.

The antenna of one embodiment may also include a tuning element electrically connected to the first end of the second radiator. The antenna may also include a third radiator extending from a first end that is configured to be grounded to a second end that is electrically open. In one embodiment, the third radiator may be positioned on an opposite side of the first radiator relative to the coupling region such that a second coupling region is defined between parallel portions of the third radiator and the first radiator. In an alternative embodiment, the third radiator may be positioned between the first radiator and a portion of the second radiator. In this alternative embodiment, the coupling region may be proximate the second end of the first radiator.

In another embodiment, a portable electronic device is provided that includes a housing, a ground plane, radio frequency circuitry disposed within the housing and the first antenna disposed within the housing. The first antenna includes a first radiator extending from a first end electrically coupled to the radio frequency circuitry to a second end that is electrically open. The first antenna also includes a second radiator extending from a first end that is electrically coupled to the ground plane to a second end that is electrically open. The second end of one of the first or second radiators is electrically coupled to the other of the first or second radiators at a coupling region between the first and second ends of the other of the first or second radiators. For example, the second end of the second radiator may be electrically coupled to the first radiator at a location between the first and second ends of the first radiator.

The first antenna of one embodiment may also include a tuning element electrically connected to the first end of the second radiator. The first antenna of one embodiment may also include a third radiator extending from the first end that is configured to be grounded to a second end that is electrically open. In one embodiment, the third radiator is positioned on an opposite side of the first radiator relative to the coupling region such that a second coupling region is defined between parallel portions of the third radiator and the first radiator. In another embodiment, the third radiator is positioned between the first radiator and a portion of the second radiator.

The portable electronic device of one embodiment may also include a second antenna disposed within the housing. The second antenna of this embodiment includes a first radiator extending from a first end electrically coupled to the radio frequency circuitry to a second end that is electrically open. The second antenna also includes a second radiator extending from a first end that is electrically coupled to the ground plane to a second end that is electrically open. The second end of one of the first or second radiators of the second antenna is electrically coupled to the other of the first or second radiators of the second antenna at a coupling region between the first and second ends of the other of the first or second radiators. The first and second antennas of this embodiment may be positioned at one end of the housing.

In a further embodiment, a method is provided that includes providing an antenna having a first radiator extending from a first end to a second end that is electrically open and a second radiator extending from a first end that is electrically coupled to the ground plane to a second end that is electrically open. The second end of one of the first or second radiators is electrically coupled to the other of the first or second radiators at a coupling region between the first and second ends of the other of the first or second radiators. The method of this embodiment also includes coupling radio frequency signals to the first end of the first radiator of the antenna.

In one embodiment, the method provides the antenna by providing the antenna with the second end of the second radiator being electrically coupled to the first radiator to a location between the first and second ends of the first radiator. The method of one embodiment may provide the antenna by providing an antenna that further includes a tuning element electrically connected to the first end of the second radiator. In one embodiment, the method may provide the antenna by providing an antenna that further includes a third radiator extending from a first end that is configured to be grounded to a second end that is electrically open.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 is a perspective view of portable electronic device that includes an antenna in accordance with one embodiment of the present invention;

FIG. 2a-2c are block diagrams illustrating the coupling of a ground plane and radio frequency circuitry to an antenna in accordance with example embodiments of the present invention;

FIG. 3 is a perspective view of an antenna in accordance with one embodiment of the present invention;

FIG. 4 is another perspective view of the antenna of FIG. 3 in accordance with an example embodiment of the present invention;

FIG. 5 is a Smith chart that provides an impedance view of an antenna in accordance with an example embodiment of the present invention in which a plurality of points are labeled in terms of frequency (GHz) and the real and imaginary components of impedance (Ohms);

FIG. 6 is a graphical representation of the S-parameter (S11, Return Loss) response of an antenna in accordance with an example embodiment of the present invention as a function of frequency;

FIGS. 7a-7c are block diagrams illustrating the tuning of an antenna in accordance with example embodiments of the present invention;

FIG. 8 is a graphical representation of the S-parameter (S11, Return Loss) of an antenna that has been dynamically tuned in accordance with an example embodiment of the present invention;

FIG. 9 is a graphical representation of the total efficiency of the antenna that has been dynamically tuned as shown in FIG. 8 in accordance with an example embodiment of the present invention;

FIG. 10 is a perspective view of a pair of antennas in accordance with an example embodiment of the present invention;

FIG. 11 is a graphical representation of the S-parameter response of a pair of antennas, such as shown in FIG. 10, in accordance with an example embodiment of the present invention;

FIG. 12 is a graphical representation of the total efficiency of a pair of antennas having the S-parameter response shown in FIG. 11 in accordance with an example embodiment of the present invention;

FIG. 13 is a perspective view of a pair of antennas in accordance with another example embodiment of the present invention; and

FIG. 14A, FIG. 14B and FIG. 14C are graphical representations of the S-parameter response of a pair of antennas, such as shown in FIG. 13, that have been dynamically tuned for different frequency bands in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

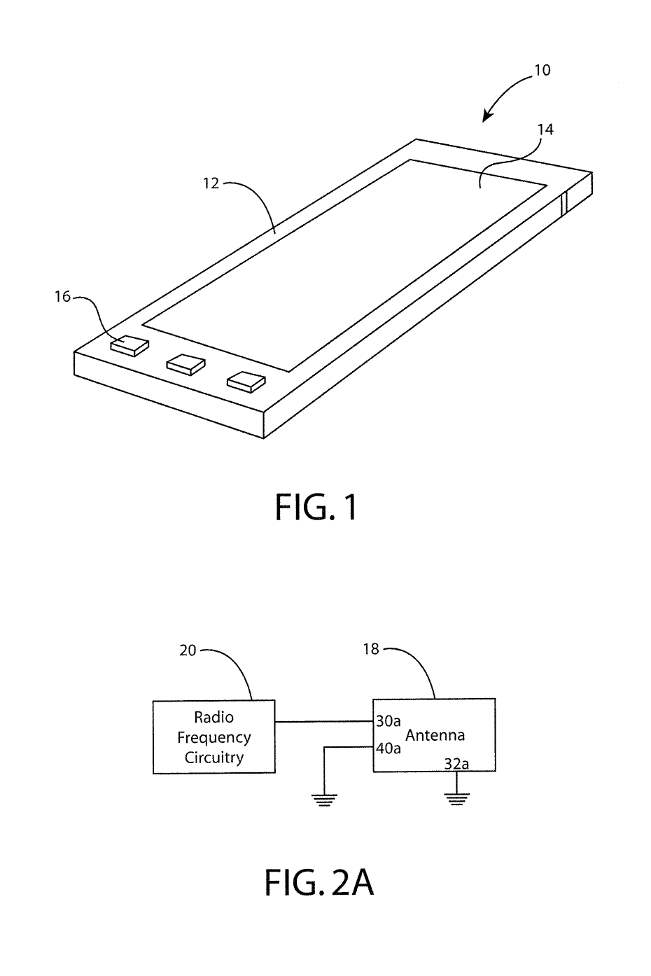

A variety of portable electronic devices may include one or more antennas for supporting wireless communications with another device, with a network or otherwise. Although one example of a portable electronic device 10 is illustrated in FIG. 1, a portable electronic device that includes an antenna for supporting wireless communications may be embodied in various manners such as a PDA, mobile telephone, smart phone, pager, mobile television, gaming device, laptop computer, camera, tablet computer, touch surface, video recorder, audio/video player, radio, electronic book, positioning device (e.g., GPS device), or any combination of the aforementioned, and other types of voice and text communications systems. A portable electronic device may include a housing 12 that protects a number of internal components. In the illustrated embodiment, the portable electronic device also includes a display 14 and one or more buttons 16 for providing user input. In other embodiments in which the display is a touch screen, the portable electronic device may optionally include one or more buttons. As such, the portable electronic device of some embodiments in which the display is a touch screen may not include any buttons.

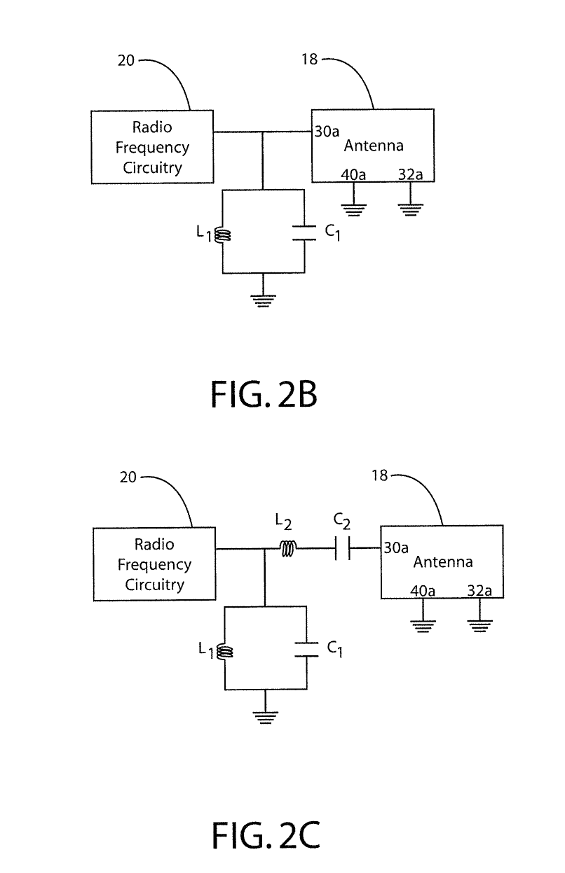

As shown in FIG. 2, the internal components of a portable electronic device 10 may include, among other components, one or more antennas 18, a system ground, such as a ground plane as discussed below, and electronic circuitry, such as one or more processors, one or more memories, radio frequency circuitry 20, etc. The radio frequency circuitry may be any means such as a device or circuitry embodied in either hardware or a combination of hardware and software that is configured to receive and/or transmit voice, data or voice and data simultaneously via the antenna. The radio frequency circuitry may include, for example, a transmitter, a receiver, a transceiver or the like. In an embodiment in which the system ground is established by a ground plane, the portable electronic device may include a printed wiring board (PWB) with the ground plane being incorporated as at least one layer therewithin. However, the portable electronic device may define system ground, such as providing a ground plane in other manners that are independent of a PWB or in addition to a PWB, such as being provided by other conductive components of the device like, and not limited to, batteries, display frames, electromagnetic shielding enclosures, support frames, conductive housing parts or other conductive electrical or mechanical components. The ground plane may therefore be two dimensional or three dimensional. If the PWB ground plane is included, then the one or more conductive objects may be galvanically coupled to the PWB ground plane layer with or without intervening components. In an example embodiment, the at least one layer of the ground plane provided by the PWB may be completely filled with conductive material or only be a fractional proportion of the total area of the layer. The fractional proportion of this embodiment may be dependent on the operational frequency and hence wavelength of the one or more antennas in use.

Although the antenna 18 may be positioned at various locations within the housing 12 of the portable electronic device 10, the antenna of one embodiment is positioned proximate one end of the housing. The antenna may be configured to support wireless communications in one or more frequency bands. By way of example, but not of limitation, the antenna of one embodiment may be configured to support wireless communications in both one or more low frequency bands and one or more high frequency bands.

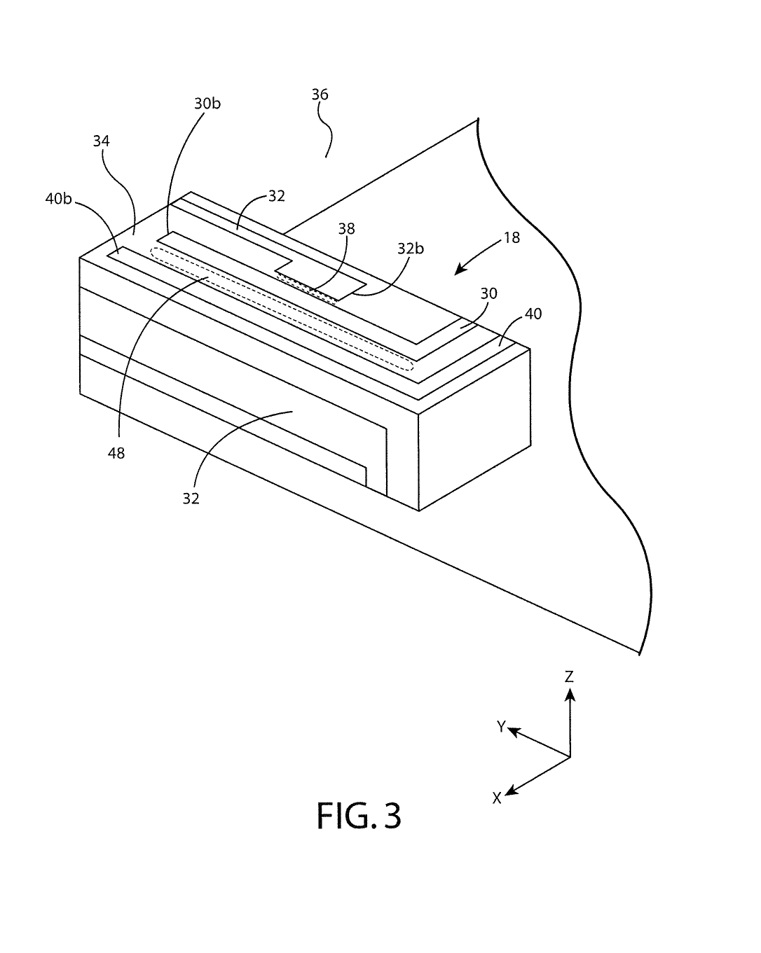

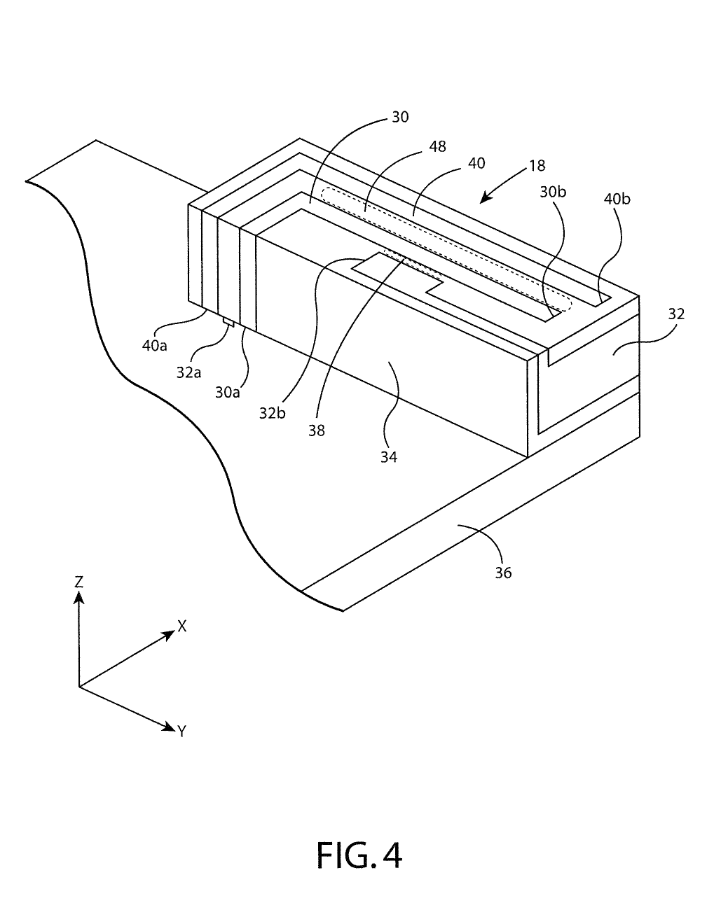

As shown in FIGS. 3 and 4, an antenna 18 of one embodiment includes the first and second radiators 30, 32 that may each be formed of a conductive material, such as copper (Cu), nickel (Ni) plated Cu or Ni-gold (Ni—Au) plated Cu, that is deposited upon a substrate 34, such as an insulative substrate that may be formed, for example, of a polycarbonate (PC) or a PC blended with acrylonitrile butadiene styrene polymer (ABS) or other suitable low loss (to radio frequencies) material which can support the first and second radiators. The insulative substrate 34 may, in turn be supported by a mechanically supportive low loss (to radio frequencies) material 36, such as PC/ABS plastic, FR4 printed wiring board (PWB) substrates or the like. For example, a PWB may include a plurality of conductive and non-conductive layers including at least one conductive layer that defines a ground plane. The PWB may also provide for electrical connection between the radio frequency circuitry 20 and the antenna, such as the first radiator.

In an example embodiment, the first and second radiators 30, 32 may be provided by, and not limited to: sheet metal parts which are heat staked or adhered to the substrate 34; a separate multi-layered flexi-circuit film having a non-conductive layer (support layer) and a conductive layer (which provides the antenna radiator patterns 30, 32) where the film is adhered to the substrate 34 or another part of the portable electronic device; a molded interconnect device (MID) where the conductive traces (radiators 30, 32) are formed by plating a platable first shot plastic part as part of the substrate 34 and the non-conductive portions of the substrate 34 are provided by a second shot plastic which is not platable; a laser direct structured (LDS) part having a substrate 34 which has one or more surfaces which are laser etched to provide a conductive pattern (antenna radiators 30, 32) and other manufacturing technologies as known in the art. The radiators 30, 32 may also be provided without a substrate 34 and instead be adhered to a different part located in the portable electronic device, such as, and not limited to, an external cover of the device.

The first radiator 30 may be a monopole that extends from a first end 30a that is electrically coupled to the radio frequency circuitry 20 (not illustrated in FIGS. 3 and 4) to an opposed, second end 30b that is electrically open. As used herein, coupling shall include both galvanic (direct connection) and electromagnetic (connection across a non-conductive region) coupling. In the illustrated embodiment, for example, the first radiator 30 extends in the +Z direction from the first end 30a at which the first radiator is electrically coupled to the radio frequency circuitry 20. The first radiator then turns so as to extend in the +X direction prior to again turning and extending for the majority of its length in the +Y direction to the second end 30b that is electrically open. Although the first radiator may have different lengths, the first radiator of one embodiment has an electrical length of about a quarter wavelength for frequencies within the high frequency band.

The second radiator 32 may be formed as an antenna which is fed by the first radiator 30 by electromagnetic coupling that extends from a first end 32a that is grounded, such as by being electrically coupled to the ground plane, to a second end 32b that is electrically open. In the embodiment of FIGS. 3 and 4, for example, the second radiator 32 may extend beneath the insulative substrate 34 in the +X direction from the first end 32a that is electrically coupled to the ground plane. As shown in FIGS. 3 and 4, the second radiator may then extend about the sidewalls of the insulative substrate, first in the +Z direction, then in the +Y direction, the −X direction and the +Z direction. The second radiator then extends along the upper surface of the insulative substrate 34 in the −Y direction to the second end 32b that is electrically open. As such, the second radiator 32 extends about a majority of the first radiator 30 including the second end 30b of the first radiator that is electrically open. Together the first and second radiators 30, 32 being configured to electromagnetically couple between at least one portion of each of the radiators form a capacitively-coupled loop antenna.

The second end 30b, 32b of one of the first or second radiators 30, 32 is electrically coupled to the other of the first or second radiators at a coupling region between the first 30a, 32a and second ends 30b, 32b of the other of the first or second radiators 30, 32. In the embodiment of FIGS. 3 and 4, the second end 32b of the second radiator 32 is electrically coupled to the first radiator 30 at a location between the first and second ends 30a, 30b of the first radiator 30. In this regard, the second radiator 32 may include an enlarged portion proximate the second end 32b of the second radiator 32 such that the spacing between the enlarged portion at the second end 32b of the second radiator 32 and the first radiator 30 is reduced relative to the spacing between other portions of the first and second radiators, thereby defining a coupling region 38. Although the coupling region 38 may be positioned at various locations along the length of the first radiator 30, the antenna of the embodiment illustrating FIGS. 3 and 4 locates the coupling region proximate a medial portion of the first radiator 30. The coupling region 38 permits the first and second radiators 30, 32 to be electrically coupled.

The impedance of the second radiator 32 may be defined by the position and length of the coupling region 38 and the resonance frequency of the second radiator maybe defined by the overall loop length provided by the combination of the first radiator 30, the coupling region 38 and the second radiator 32.

As also shown in the embodiment of FIGS. 3 and 4, the antenna 18 of one embodiment may also include a third radiator 40. The third radiator may also be formed of a conductive material, such as, and not limited to, Cu, Ni plated Cu or Ni—Au plated Cu, that is deposited upon the substrate 34. The third radiator may also be a monopole so as to extend from a first end 40a that is configured to be grounded, such as by being electrically coupled to the ground plane, to a second end 40b that is electrically open. In the embodiment of FIGS. 3 and 4, the third radiator is positioned on the opposite side of the first radiator 30 relative to the coupling region 38 defined between the first and second radiators. In the illustrated embodiment, the third radiator 40 extends in the +Z direction from the first end 40a that is configured to be grounded and then in the +X direction prior to extending for the majority of its length along the +Y direction to the second end 40b that is electrically open.

Although the second end of the third radiator extends further in the +Y direction than the second end 30b of the first radiator in the illustrated embodiment, the second ends 30b, 40b of the first and third radiators 30, 40 may extend the same length or the second end 30b of the first radiator 30 may extend further than the second end 40b of the third radiator 40 in other embodiments. Regardless, the third radiator 40 may extend alongside a majority of the first radiator 30, such as in the Y direction, with the first and third radiators of one embodiment optionally being parallel. In other embodiments, the conductive parts which form the radiators 30, 32, and 40, may not be exactly parallel and may also be other shapes other than the rectangular forms as shown in the figures, and additionally may also lie in different planes to one another. As such, a second coupling region 48 may also be defined as generally shown by the dashed outline between the first and third radiators 30, 40, such as between those portions of the first and third radiators that extend in parallel to one another, such as in the Y direction in the illustrated embodiment.

The antenna 18 of an example embodiment supports communications in both a low frequency band, such as communications at 700 MHz, 800 MHz or 900 MHz, and communications at a high frequency band, such as 1710 MHz to 2170 MHz. In this regard, the coupled—fed loop antenna formed by the combination of the first and second radiators 30, 32 (as well as coupling region 38 therebetween) has a resonance mode that supports communications at the low frequency band, while the first radiator 30 is self-resonant in the high frequency band, thereby supporting communications within the high frequency band with the bandwidth of the high frequency band being increased by the addition of the third radiator 40 and its coupling with the first radiator 30. The low and high frequency bands may be configured independently of one another and may be tuned in a dynamic manner. As described above, for example, the combination of the first and second radiators 30, 32 may support the low frequency band with a resonant frequency defined by the overall loop length of the combination of the first and second radiators. Additionally, the impedance at the high frequency band may be controlled by the coupling between the first and third radiators 30, 40 and the resonance frequencies within the high frequency band may be controlled by the lengths of the first and third radiators 30, 40. In this regard, the lengths of the first and third radiators may be slightly different which gives rise to two different resonance frequencies. These two resonance frequencies may not be too far apart in terms of resonant frequency, thereby leading to a high frequency band having a wide bandwidth.

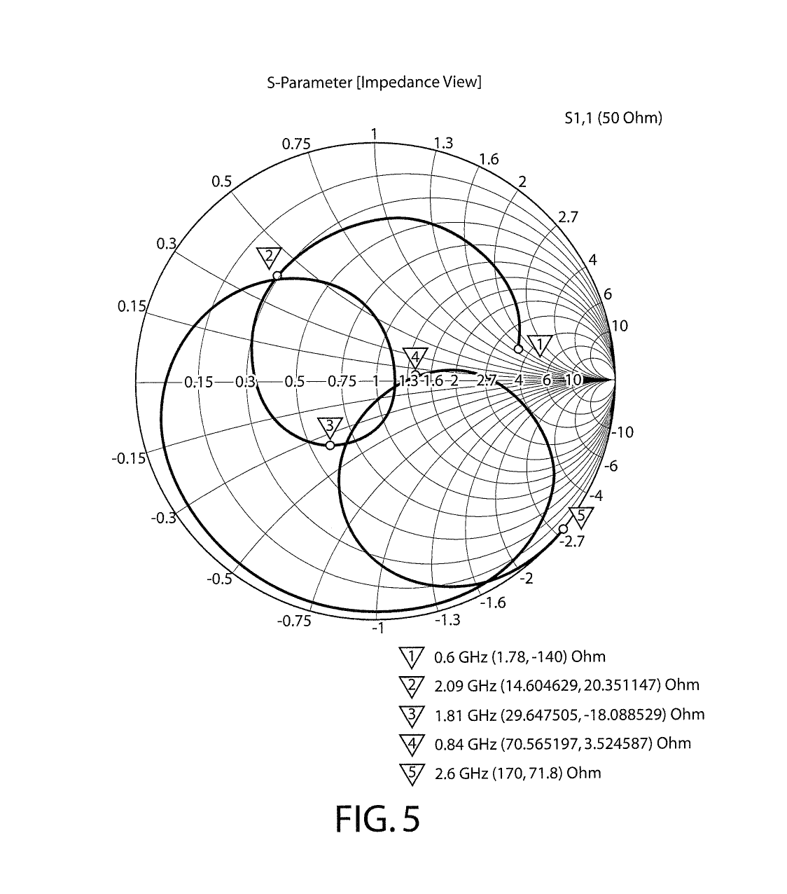

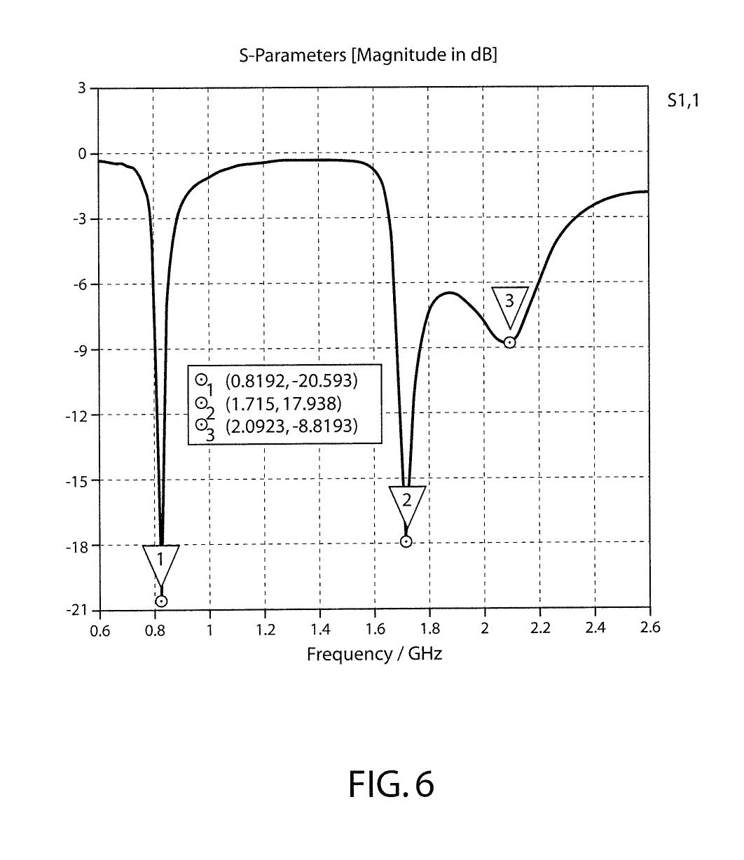

By way of example, the Smith chart of FIG. 5 illustrates the impedance characteristics of the antenna of one example embodiment. In this regard, the antenna impedance as represented by the Smith chart may be conveniently matched by a combination of shunt reactive elements. In this regard, FIG. 2b illustrates an example embodiment in which the antenna impedance is matched with a matching circuit formed of an inductor L₁ and a capacitor C₁ arranged in parallel. FIG. 2c illustrates another embodiment in which a series L₂-C₂ circuit is utilized to rotate the impedance loci before matching with the shunt L₁-C₁ circuit. Additionally, the return loss (S-parameter, S11) of a matched antenna in accordance with one embodiment of the present invention is illustrated in FIG. 6 in decibels (dB) as a function of frequency in GHz. As shown, the antenna of this example embodiment exhibits one resonance at a low frequency band, e.g., 0.82 GHz, and two resonances within a high frequency band, e.g., 1.71 GHz and 2.09 GHz. In this regard, an antenna having the return loss of FIG. 6 may be configured to primarily radiate from the combination of the first and second radiators 30, 32 at 0.82 GHz and primarily from the first and third radiators 30, 32 at 1.71 GHz and 2.09 GHz.

The loop antenna is utilized in a first resonance mode, which is an anti-resonance mode characterized by a high impedance. This resonance mode may be matched to 50 ohms by a series capacitor at a frequency at which the impedance loci crosses the 50 ohm impedance circle prior to reaching anti-resonance such that the loop may be shorter than 0.5λ. However, the capacitor would have a very small value and the loop antenna would exhibit a very narrow bandwidth. The coupled-fed loop antenna of an embodiment of the present invention utilizes the distributed capacitance of the coupling region 38 to match the loop to 50 ohms, thus allowing the loop to be shorter by transforming the impedance at a lower frequency. The bandwidth of the coupled-fed loop antenna of this embodiment may be wider than that of a loop matched with a series capacitor. The size of the coupling region and the overall length of the loop may depend on the position of the coupling region 38. In one example embodiment, the loop length is about 0.23λ in free space, e.g. 84 mm which is 0.23λ at 0.82 GHz in free space, but the effective electrical length may be longer once the plastic and PWB components and their effect upon the effective dielectric constant are considered. Thus, the coupled-fed loop antenna of an example embodiment may be substantially smaller than the loop antennas of conventional mobile terminals.

By forming a coupled-fed loop antenna by the combination of the first and second radiators 30, 32 and the coupling region 38 therebetween, the capacitance between the first and second radiators within the capacitive coupling region 38 allows the overall loop structure to be shortened relative to at least some loop antennas employed by conventional portable electronic devices such that the first and/or second radiators may also be made shorter. By way of example, the overall loop length as defined by the combination of the first and second radiators 30, 32 and the coupling region 38 therebetween of one example embodiment is approximately 0.23λ at 0.82 GHz, but the effective electrical length may be longer considering the antenna is placed over a plastic substrate 34 which, in turn, is at least partially supported by an FR4 board. In one embodiment, the capacitive coupling region 38 may be increased by, instead, placing the conductive traces of the first and second radiators 30, 32 above each other (e.g., in the Z direction) rather than side by side as shown in the illustrated embodiment, thereby providing for broadside coupling instead of edge coupling as shown in the illustrated embodiments. The traces can also be widened to increase capacitance and/or the gap therebetween can be decreased to increase capacitive coupling.

The antenna of one embodiment may be configured to be dynamically tuned at the low frequency band without significantly affecting the high frequency band. In this embodiment, a tuning element may be electrically connected to the first end 32a of the second radiator 32, such as by being connected between the first end 32a and the ground plane. While the tuning element may be configured in various manners, the tuning element of one embodiment may include a reactive element, such as an inductor in order to reduce the frequency of the antenna or a capacitor in order to increase the frequency of the antenna. In one embodiment, the antenna maybe designed to support the lowest frequency band of interest such that only a tuning element in the form of a capacitor would need to be used in an instance in which the antenna is desired to be tuned to a higher frequency band.

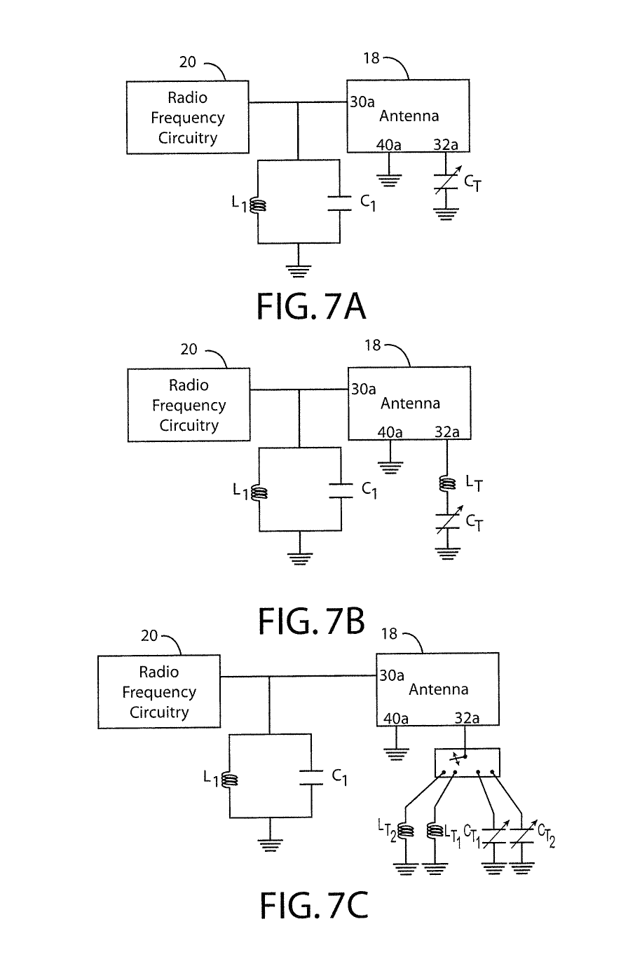

As shown by way of example and not of limitation, an antenna 18 that is configured to be tuned at low band is shown in FIG. 7a. In this embodiment, a variable capacitor C_{T} may be coupled to the first end 32a of the second radiator 32 to provide for tuning at low band with only a small effect at high band. In this embodiment, a digital variable capacitor C_{T} may permit the antenna 18 to be tuned to high frequencies (at low band) with the smaller the values of the capacitor providing for a higher tuning frequency. If the coupled-fed loop is not sufficiently long to cover the lowest frequency of interest, an inductor L_{T} may be added as shown in FIG. 7b to lower the frequency to a desired frequency and the variable capacitor may then be utilized to shift higher in frequency. In an alternative embodiment shown in FIG. 7c, a switch, such as a SP4T switch, may be utilized in conjunction with one or more inductors L_{T1}, L_{T2} and one or more capacitors C_{T1}, C_{T2}. In this embodiment, the antenna 18 may be tuned from band B17 (725 MHz) to band B8 (900 MHz). In this regard, the antenna 18 may be initially tuned at a frequency between the B13 (766 MHz) and B5 (85 MHz) bands. In the embodiment illustrated in FIG. 7c, the inductor L_{T2} may tune the antenna 18 to band B7. The inductor L_{T1} that has a smaller value than inductor L_{T2} may tune the antenna 18 to band B13. The capacitor C_{T1} may tune the antenna 18 to band B5 and capacitor C_{T2} having a smaller value than C_{T1} may tune the antenna to band B8.

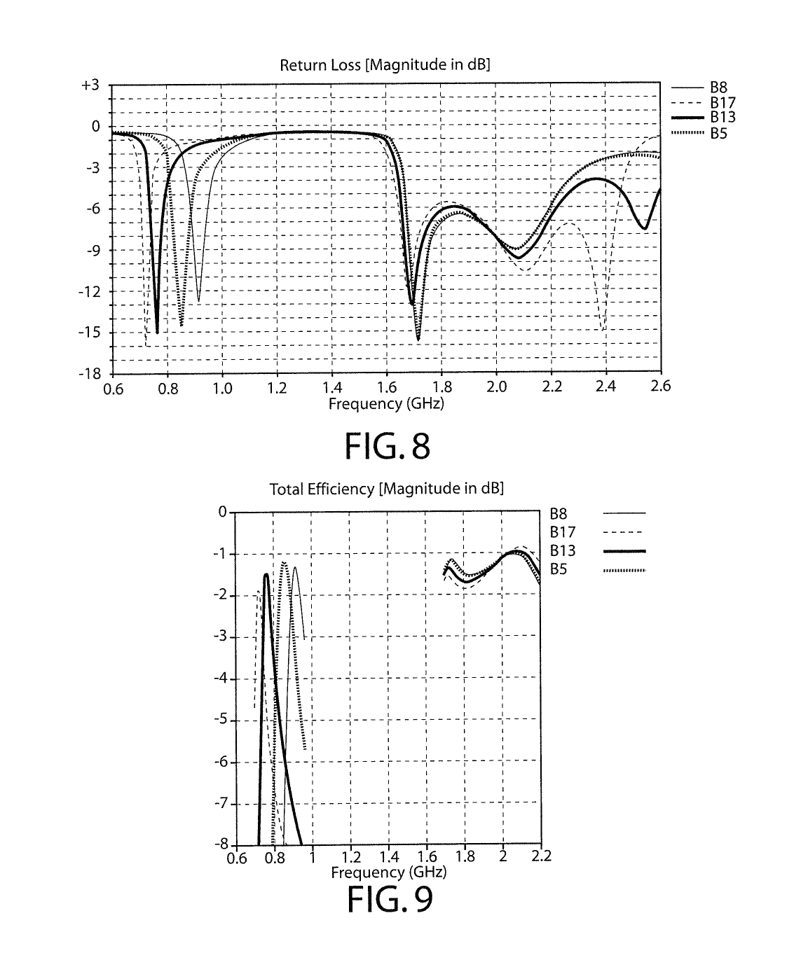

By way of example, the antenna of one embodiment may be designed such that the low frequency band is frequency band B5, that is, 824 MHz-894 MHz. However, the antenna of this embodiment may be tuned downwardly with the addition of an inductive tuning element to frequency band B13, that is, 746 MHz-787 MHz, or to frequency band B17, that is, 704 MHz-746 MHz, or upwardly with the addition of a capacitive tuning element to frequency band B8, that is, 880 MHz-960 MHz. FIGS. 8 and 9 illustrate the simulated return loss and the antenna efficiency, respectively, of a dynamically tuned antenna that is designed to support frequency band B5, but that may be tuned down to support frequency bands B13 or B17 or up to support frequency band B8. As shown in FIGS. 8 and 9 in dB as a function of frequency in GHz, the antenna of this embodiment may be dynamically tuned at low frequency bands with little, if any, effect upon the high frequency band. While a tuning element in a form of a dynamically tuned capacitor may be adequate to tune an antenna from frequency band B17 to higher frequencies up to frequency band B8, the required capacitance range may be relatively large. A tuning element that includes a switch and/or various reactive components, such as inductors and/or capacitors, may be utilized for tuning the antenna to higher or lower frequencies, such as to cover frequency bands from frequency band B17 to frequency band B8.

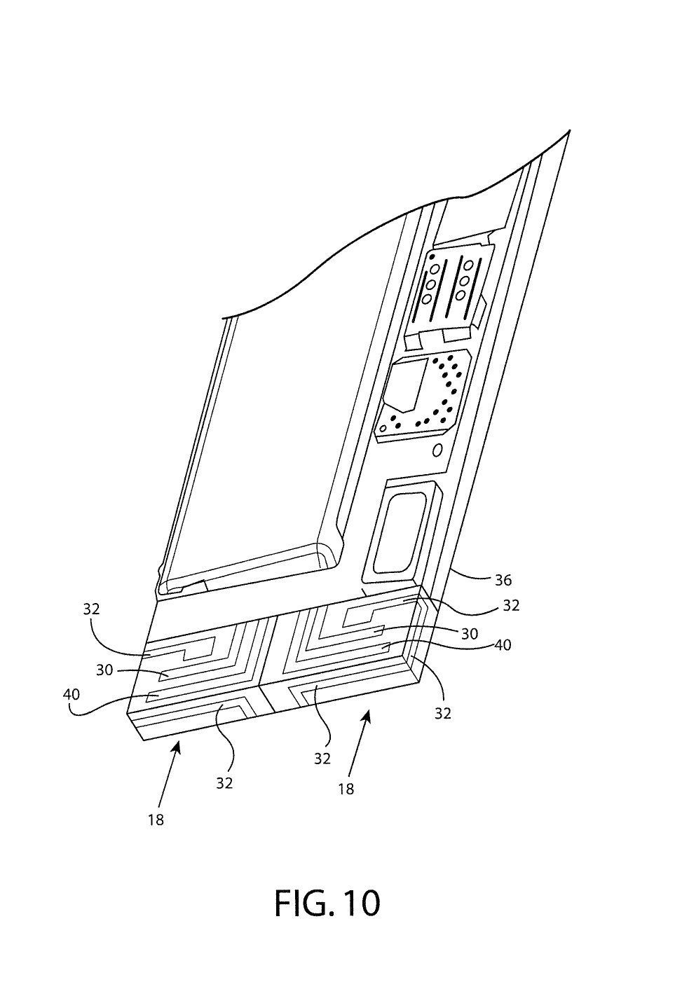

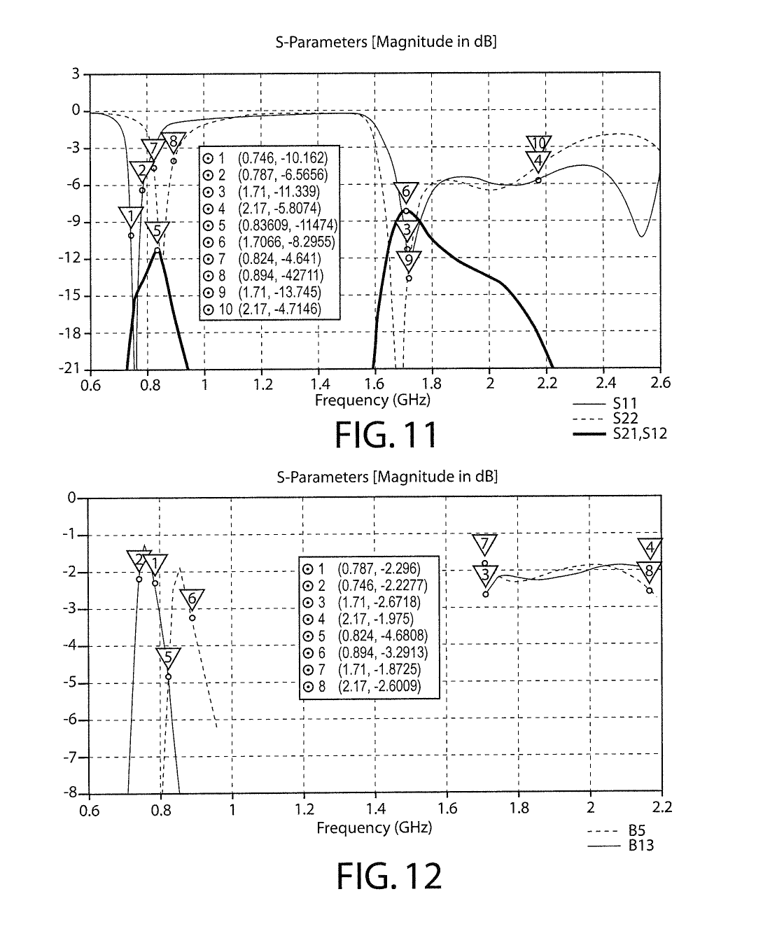

The antenna of an example embodiment of the present invention may be relatively compact and, as such, may be smaller compared to conventional pentaband or hexaband antennas. As a result of its relatively compact size, a portable electronic device 10 may include two or more antennas, such as of the type described above. In this regard, the portable electronic device may include a pair of antennas to support advanced wireless communications systems, such as SV-LTE, MIMO or diversity applications. Although the pair of antennas maybe disposed within the housing 12 of a portable electronic device in various manners, the pair of antennas may be positioned proximate one another, such as at the bottom of the housing in one embodiment. By way of example, a pair of antennas 18 configured to support an SV-LTE application are shown in FIG. 10. In this regard, the pair of antennas may be located proximate one another in order to maintain the compact size of the portable electronic device, but may also advantageously maintain isolation therebetween. By way of example, one antenna of the pair may be designed to support the low frequency band B13 (746 MHz-787 MHz) and the high frequency band (1710 MHz-2170 MHz), while the other antenna may be designed to support the low frequency band B5 (824 MHz-894 MHz) and the high frequency band (1710 MHz-2170 MHz). As such, the pair of antennas of this embodiment may not require a tuning element for dynamic antenna tuning. The S-parameters and the total efficiency of the pair of antennas configured to support an SV-LTE application shown in FIG. 10 are graphically represented by FIGS. 11 and 12, respectively, in dB as a function of frequency in GHz. With respect to FIG. 11, it is noted that the curve for S21 which is illustrated is identical to the curve for S11.

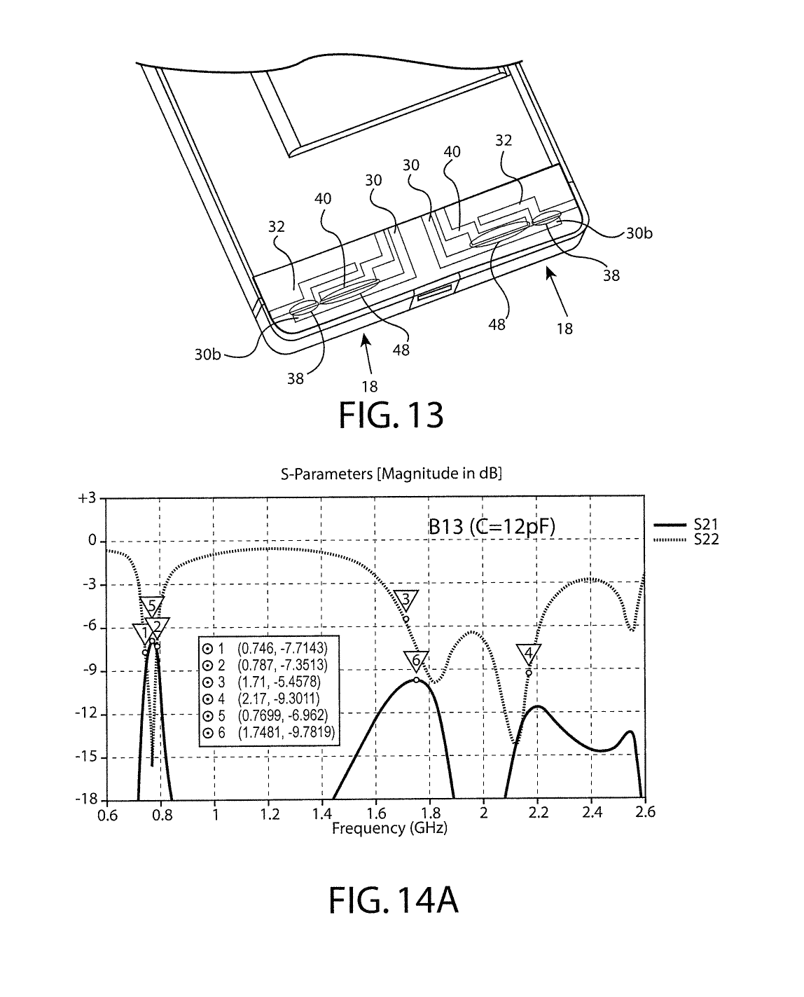

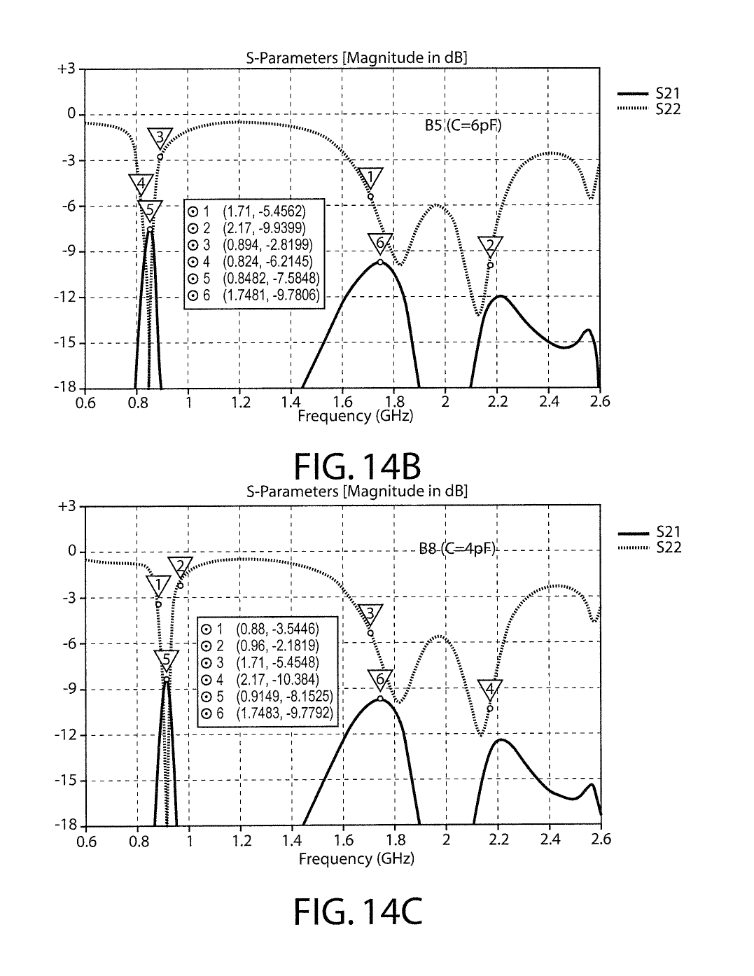

A portable electronic device 10 that is configured to support a 2×2 MIMO application may also include a pair of antennas 18 as shown, for example, in FIG. 13. In this embodiment, the relative positions of the first and third radiators 30, 40 may be interchanged such that the third radiator 40 is positioned between the first radiator 30 and a portion of the second radiator 32. Additionally, the coupling region 38 defined by the enlarged portion of the second radiator may be repositioned so as to no longer be proximate the second end 32b of the second radiator, but may be positioned at a medial portion of the second radiator proximate the second end 30b of the first radiator. As such, both antennas may be operable over the same frequency bands simultaneously. However, each antenna maybe dynamically tuned in the manner described above in conjunction with the embodiment depicted in FIGS. 3 and 4. By way of example, the pair of antennas of the embodiment of FIG. 13 may be dynamically tuned to support frequency band B13 with a capacitor of 12 pF with a graphical representation of the S-parameters of the resulting antenna shown in FIG. 14A in dB as a function of frequency in GHz. Similarly, the pair of antennas of the embodiment of FIG. 13 may be dynamically tuned to support frequency band B5 with a capacitor of 6 pF or to support frequency band B8 with a capacitor of 4 pF with the graphical representations of the S-parameters of the resulting antennas being shown in FIGS. 14B and 14C, respectively, in dB as a function of frequency in GHz. With respect to FIGS. 14A-14C, it is noted that the curves for S21 and S22 which are illustrated are identical to the curves for S12 and S11, respectively.

Although the pair of antennas may operate simultaneously, the portable electronic device 10 may also be configured to switch between the pair of antennas and, as such, may include a switch. As such, the antennas may be configured to support different frequency bands, such as different low frequency bands, with the switch selecting the antenna to be active based upon the desired frequency band. Further, the pair of antennas could be both dynamically tuned and switched to provide further size reduction to each of the antenna pairs.

As described above, an antenna 18 may be designed in accordance with an example embodiment to the present invention so as to have a relatively small size, while being configured to be independently tuned for within both a low frequency band and a high frequency band. Thus, the antenna of one embodiment of the present invention may be utilized by portable electronic devices 10 so as to support the additional requirements imposed by advances in wireless communication systems, such as diversity, MIMO and SV-LTE applications, while permitting the portable electronic devices to continue to be relatively small and aesthetically pleasing in appearance. It should also be appreciated that multiple antennas may be configured in accordance with an example embodiment to be switched or selectable so that the detrimental effect on the performance of one or more antennas when a part of the user's body is in close vicinity of the one or more antennas is avoided. In this embodiment, the antenna that is the furthest away from the part of the user's body is selected for operation so that efficient radiation occurs and the signals that are transmitted and/or received are not detrimentally affected.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising:
a first radiator extending from a first end configured to be coupled to radio frequency circuitry to a second end that is electrically open; and
a second radiator extending from a first end that is configured to be grounded to a second end that is electrically open,
wherein the second end of one of the first or second radiators is electrically coupled to the other of the first or second radiators at a coupling region between the first and second ends of the other of the first or second radiators, and wherein the second end of the second radiator is electrically coupled to the first radiator at a location between the first and second ends of the first radiator.

2. An apparatus according to claim 1 wherein a combination of the first radiator, the second radiator and the coupling region therebetween comprises a loop antenna.

3. An apparatus according to claim 1 further comprising a tuning element electrically connected to the first end of the second radiator.

4. An apparatus according to claim 1 further comprising a third radiator extending from a first end that is configured to be grounded to a second end that is electrically open.

5. An apparatus according to claim 4 wherein the third radiator is positioned on an opposite side of the first radiator relative to the coupling region, wherein a second coupling region is defined between parallel portions of the third radiator and the first radiator.

6. An apparatus according to claim 4 wherein the third radiator is positioned between the first radiator and a portion of the second radiator.

7. An apparatus according to claim 6 wherein the coupling region is proximate the second end of the first radiator.

8. An apparatus comprising:
a housing;
a ground plane;
radio frequency circuitry disposed within the housing; and
a first antenna disposed within the housing and comprising a first radiator extending from a first end electrically coupled to the radio frequency circuitry to a second end that is electrically open and a second radiator extending from a first end that is electrically coupled to the ground plane to a second end that is electrically open, wherein the second end of one of the first or second radiators is electrically coupled to the other of the first or second radiators at a coupling region between the first and second ends of the other of the first or second radiators, and wherein the second end of the second radiator is electrically coupled to the first radiator at a location between the first and second ends of the first radiator.

9. An apparatus according to claim 8 wherein a combination of the first radiator, the second radiator and the coupling region therebetween comprises a loop antenna.

10. An apparatus according to claim 8 wherein the first antenna further comprises a tuning element electrically connected to the first end of the second radiator.

11. An apparatus according to claim 8 wherein the first antenna further comprises a third radiator extending from a first end that is configured to be grounded to a second end that is electrically open.

12. An apparatus according to claim 11 wherein the third radiator is positioned on an opposite side of the first radiator relative to the coupling region, wherein a second coupling region is defined between parallel portions of the third radiator and the first radiator.

13. An apparatus according to claim 11 wherein the third radiator is positioned between the first radiator and a portion of the second radiator.

14. An apparatus according to claim 8 wherein the coupling region is proximate the second end of the first radiator.

15. An apparatus according to claim 8 further comprising a second antenna disposed within the housing and comprising a first radiator extending from a first end electrically coupled to the radio frequency circuitry to a second end that is electrically open and a second radiator extending from a first end that is electrically coupled to the ground plane to a second end that is electrically open, wherein the second end of one of the first or second radiators is electrically coupled to the other of the first or second radiators at a coupling region between the first and second ends of the other of the first or second radiators.

16. An apparatus according to claim 15 wherein the first and second antennas are positioned at one end of the housing.

17. A method comprising:
providing an antenna comprising a first radiator extending from a first end to a second end that is electrically open and a second radiator extending from a first end that is electrically coupled to the ground plane to a second end that is electrically open, wherein the second end of one of the first or second radiators is electrically coupled to the other of the first or second radiators at a coupling region between the first and second ends of the other of the first or second radiators, and wherein the second end of the second radiator is electrically coupled to the first radiator at a location between the first and second ends of the first radiator; and
coupling radio frequency signals to the first end of the first radiator of the antenna.

18. A method according to claim 17 wherein a combination of the first radiator, the second radiator and the coupling region therebetween comprises a loop antenna.

19. A method according to claim 17 wherein providing the antenna comprises providing the antenna that further comprises a tuning element electrically connected to the first end of the second radiator.

20. A method according to claim 17 wherein providing the antenna comprises providing the antenna that further comprises a third radiator extending from a first end that is configured to be grounded to a second end that is electrically open.
